(19) United States
(12) Patent Application Publication
(10) Pub. No.: US 2022/0206554 A1
(43) Pub. Date: Jun. 30, 2022

(54) PROCESSOR AND POWER SUPPLY RIPPLE REDUCTION METHOD

(71) Applicant: Shenzhen Yuntianlifei Technologies Co., Ltd, Shenzhen, Guangdong (CN)

(72) Inventors: Qinghai KONG, Shenzhen, Guangdong (CN); Wei LI, Shenzhen, Guangdong (CN); Qingxin CAO, Shenzhen, Guangdong (CN); Hoguo WANG, Shenzhen, Guangdong (CN)

(21) Appl. No.: 17/623,603

(22) PCT Filed: Aug. 13, 2020
(86) PCT No.: PCT/CN2020/108984

§ 371 Date: Dec. 29, 2021

(30) Foreign Application Priority Data
Dec. 10, 2019 (CN) 201911261783.8

(51) Int. Cl. G06F 1/30; G06F 1/10

(52) U.S. Cl. CPC G06F 1/305; G06F 1/10

(57) ABSTRACT

A processor and a power supply ripple reduction method are provided. The processor is connected to a power supply and an external memory and includes a controller, a power control unit and a processing unit. The processing unit includes an input buffer, an arithmetic unit, and an output buffer. The controller is used to determine an initial waiting cycle number N1 and a waiting cycle decrement number N2 of the processing unit. The power supply control unit is used to transmit, when the processor starts operations, a first control signal to the processing unit according to N1 and N2. The processing unit reads, upon receiving the first control signal, data to be processed from the external memory (12), buffers the read data in the input buffer, transmits the buffered data from the input buffer to the arithmetic unit to perform computation, and saves a computation result into the output buffer.

### 1. TECHNICAL FIELD

The present disclosure generally relates to computers field, and especially relates to a processor and a power supply ripple reduction method for reducing the power supply ripple when the processor starts working. This application claims priority to Chinese Patent Application No. 201911261783.8 entitled “PROCESSOR AND POWER SUPPLY RIPPLE REDUCTION METHOD” and filed on Dec. 10, 2019, the content of which is hereby incorporated by reference in its entirety.

### 2. DESCRIPTION OF RELATED ART

With the development of computers, processors (such as central processing units, graphics processing units and neural network processing units) are playing more and more role, and an energy efficiency ratio of the processor has been greatly improved. However, current requirements for computing power of the processors (such as neural network processing units) are becoming higher and higher, and the high computing power will inevitably lead to an increase of power consumption, so that a transient power consumption for starting the processor is very large. Thereby, a severe nanosecond-level current fluctuation can bring large ripples to a direct current-direct current (DC-DC) power supply, which causes an unstable operation of the processor.

### SUMMARY

The technical problems to be solved: in view of the shortcomings of the related art, the present disclosure relates to a processor and a power supply ripple reduction method which can reduce a power supply ripple when the processor starts working, and improve stability of the processor.

In a first aspect, a processor according to an embodiment of the present disclosure is connected to a power supply and an external memory, and includes a controller and at least one processing unit, the controller configured to determine an initial waiting cycle number N1 and a waiting cycle decrement number N2 of the processing unit, the at least one processing unit including an input buffer, an arithmetic unit and an output buffer; the processor further including a power control unit configured to:

transmit a first control signal to the at least one processing unit according to the initial waiting cycle number N1 and the waiting cycle decrement number N2, when the processor starts working; wherein a waiting time that the power control unit transmits the first control signal for the first time is N1 clock cycles of the processor, the waiting time for subsequently transmitting the first control signal every time is decremented by N2 clock cycles, and if the waiting time decrements to be less than or equal to zero, the first control signal is transmitted every clock cycle;

after receiving the first control signal, the at least one processing unit configured to read data to be processed from the external memory, cache the data to be processed that has been read to the input buffer, transmit the data to be processed that has been cached from the input buffer to the arithmetic unit for performing computation, and store computation results to the output buffer.

In a possible implementation, the step of determining the initial waiting cycle number N1 and the waiting cycle decrement number N2 of the processing unit includes:

obtaining a ripple voltage generated by the processor in an extreme working scenario;

determining the number of steps of current variation of the processor according to the ripple voltage generated by the processor in the extreme working scenario and a ripple voltage acceptable to the processor;

determining the waiting cycle decrement number N2 according to a switch cycle of the power supply and a clock cycle of the processor;

calculating the initial waiting cycle number N1 according to the number of steps and the waiting cycle decrement number N2.

In a possible implementation, the power control unit includes a first control register configured to store the initial waiting cycle number, a second control register configured to store the waiting cycle decrement number, and a control signal generating circuit configured to output the first control signal according to data stored in the first control register and the second control register.

In a possible implementation, the power control unit is further configured to:

if the number of remaining data to be processed in the external memory is less than or equal to a preset value, transmit a second control signal to the at least one processing unit according to the initial waiting cycle number N1 and the waiting cycle decrement number N2, wherein a waiting time that the power control unit transmits the second control signal for the first time is N2 clock cycles, the waiting time for subsequently transmitting the second control signal every time incremented by the N2 clock cycles, and if the waiting time increments to be greater than or equal to N1, the second control signal is transmitted every N1 clock cycles until the data to be processed in the external memory is completely calculated;

the at least one processing unit further configured to:

after receiving the second control signal, read the data to be processed from the external memory, cache the data to be processed that has been read to the input buffer, transmit the data to be processed that has been cached from the input buffer to the arithmetic unit for performing computation, and store computation results to the output buffer.

In a second aspect, a power supply ripple reduction method according to an embodiment of the present disclosure is applied to a processor, the processor connected to a power supply and an external memory and including a controller, a power control unit, and at least one processing unit, the at least one processing unit including an input buffer, an arithmetic unit and an output buffer; the processor further including a power control unit, the method including:

determining an initial waiting cycle number N1 and a waiting cycle decrement number N2 of the processing unit;

transmitting, by the power control unit, a first control signal to the at least one processing unit according to the initial waiting cycle number N1 and the waiting cycle decrement number N2, when the processor starts working; wherein a waiting time that the power control unit transmits the first control signal for the first time is N1 clock cycles of the processor, the waiting time for subsequently transmitting the first control signal every time is decremented by N2 clock cycles, and if the waiting time decrements to be less than or equal to zero, the first control signal is transmitted every clock cycle;

after the at least one processing unit receives the first control signal, reading data to be processed from the external memory, caching the data to be processed that has been read to the input buffer, transmitting the data to be processed that has been cached from the input buffer to the arithmetic unit for performing computation, and storing computation results to the output buffer.

In a possible implementation, the step of determining the initial waiting cycle number N1 and the waiting cycle decrement number N2 of the processing unit includes:

obtaining a ripple voltage generated by the processor in an extreme working scenario;

determining the number of steps of current variation of the processor according to the ripple voltage generated by the processor in the extreme working scenario and a ripple voltage acceptable to the processor;

determining the waiting cycle decrement number N2 according to a switch cycle of the power supply and a clock cycle of the processor; and

calculating the initial waiting cycle number N1 according to the number of steps and the waiting cycle decrement number N2.

In a possible implementation, the waiting cycle decrement number is proportional to the switch cycle of the power supply and inversely proportional to the clock cycle of the processor.

In a possible implementation, the waiting cycle decrement number is (T1*n/T2), wherein T1 is the switch cycle of the power supply, T2 is the clock cycle of the processor, and n is a positive integer greater than 1.

In a possible implementation, the power control unit includes a first control register configured to store the initial waiting cycle number, a second control register configured to store the waiting cycle decrement number, and a control signal generating circuit configured to output the first control signal according to data stored in the first control register and the second control register.

In a possible implementation, if the number of remaining data to be processed in the external memory is less than or equal to a preset value, the method further includes:

Transmitting, by the power control unit, a second control signal to the at least one processing unit according to the initial waiting cycle number N1 and the waiting cycle decrement number N2, wherein a waiting time that the power control unit transmits the second control signal for the first time is N2 clock cycles, the waiting time for subsequently transmitting the second control signal every time incremented by the N2 clock cycles, and if the waiting time increments to be greater than or equal to N1, the second control signal is transmitted every N1 clock cycles until the data to be processed in the external memory is completely calculated;

after the at least one processing unit receiving the second control signal, reading the data to be processed from the external memory, caching the data to be processed that has been read to the input buffer, transmitting the data to be processed that has been cached from the input buffer to the arithmetic unit for performing computation, and storing computation results to the output buffer.

The present disclosure is to determine the initial waiting cycle number N1 and the waiting cycle decrement number N2 of the processing unit of the processor; when the processor starts working, the power control unit of the processor is configured to transmit the first control signal to the at least one processing unit according to the initial waiting cycle number N1 and the waiting cycle decrement number N2, the waiting time that the power control unit transmits the first control signal for the first time is N1 clock cycles of the processor, the waiting time for subsequently transmitting the first control signal every time is decremented by N2 clock cycles, and if the waiting time decrements to be less than or equal to zero, the first control signal is transmitted every clock cycle; after receiving the first control signal, the at least one processing unit is configured to read data to be processed from the external memory, cache the data to be processed that has been read to the input buffer, transmit the data to be processed that has been cached from the input buffer to the arithmetic unit for performing computation, and store computation results to the output buffer.

When a conventional processor starts working, the data to be processed is sent from the external memory to the arithmetic unit for performing computation in each clock cycle, so that current requirements of the processor at a nanosecond level are greatly changed, therefore, voltage stability of the power supply is seriously affected, a large ripple is generated, and stability of the processor is also seriously affected. However, in the present disclosure, when the processor starts working, the power control unit is configured to transmit the first control signal to the processing unit according to the initial waiting cycle number N1 and the waiting cycle decrement number N2, and the waiting time that the power control unit transmits the first control signal for the first time is N1 clock cycles of the processor, the waiting time for subsequently transmitting the first control signal every time is decremented by N2 clock cycles. Since the power control unit transmits the first control signal according to a certain waiting time when initially starting the processor, rather than transmitting the first control signal to the processing unit every clock cycle, so that the processing unit can read data for performing computation according to the certain waiting time, rather than reading data for performing computation every clock cycle. In this way, power consumption requirements of the processor during starting working becomes stepped by controlling operation frequencies of the arithmetic unit in the processing unit to avoid a sharp rise of a current of the processor, and a voltage of the power supply becomes stable, so as to effectively reduce the power supply ripple when the processor starts working, and improve stability of the processor.

### Beneficial Effect

### BRIEF DESCRIPTION OF THE DRAWINGS

FIG. 1 is a block diagram of a processor in accordance with an embodiment of the present disclosure.

FIG. 2 is a schematic diagram of a ripple caused by a transient output current of the power supply changing from OA to 6A in accordance with an embodiment of the present disclosure.

FIG. 3 is a flowchart of a power supply ripple reduction method in accordance with an embodiment of the present disclosure.

FIG. 4 is a detailed flowchart of determining an initial waiting cycle number N1 and a waiting cycle decrement number N2 of a processing unit of FIG. 3.

FIG. 5 is a flowchart of a power supply ripple reduction method in accordance with another embodiment of the present disclosure.

FIG. 6 is a block diagram of a computer device in accordance with an embodiment of the present disclosure.

FIG. 7 is a block diagram of a power control unit in accordance with an embodiment of the present disclosure.

### EMBODIMENTS

### Detailed Description

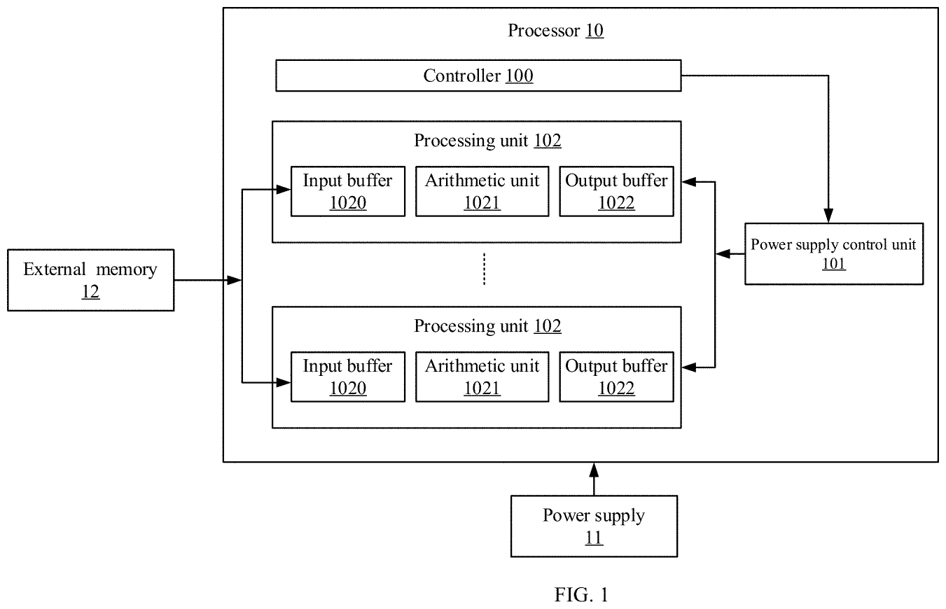

FIG. 1 illustrates a block diagram of a processor in accordance with an embodiment of the present disclosure.

In an embodiment of the present disclosure, the processor 10 includes a controller 100, a power control unit 101 and at least one processing unit 102. Each processing unit 102 includes an input buffer 1020, an arithmetic unit 1021 and an output buffer 1022. The processor 10 is connected to a power supply 11 and an external memory 12.

The processor 10 can be a central processing unit (CPU), a graphics processing unit (GPU), a field-programmable gate array (FPGA), or other types of processors.

In an embodiment of the present disclosure, the processor 10 can be a neural network processing unit (NPU). A working principle of the neural network processing unit is to simulate human neurons and synapses at a circuit layer, and directly process large-scale neurons and synapses by a deep learning instruction set. One instruction is configured to process a group of neurons. Compared with the CPU and the GPU, the NPU integrates storage and calculation through synaptic weights, so as to improve operation efficiency thereof.

The power supply 11 is configured to supply power to the processor 10 and can be a direct current-direct current (DC-DC) power supply.

The external memory 12 is configured to store data to be processed and can be a synchronous dynamic random access memory (SDRAM), a double data rate SDRAM (DDR SDRAM) or other types of memories.

The input buffer 1020 is configured to cache the data to be processed that has been read from the external memory 12.

In an embodiment of the present disclosure, the processor 10 is the NPU, and the data to be processed stored in the external memory 12 includes input data (such as images) and weights. The input buffer 1020 includes a data buffer configured to cache input data, and a weight buffer configured to cache weights.

The processor 10 can be embedded in a chip (not shown in the figures), and the chip can include one or more of processors 10.

When the conventional processor starts working, the data to be processed is sent from the external memory to the arithmetic unit for performing computation in each clock cycle, so that current requirements of the processor at the nanosecond level are greatly changed, therefore, voltage stability of the power supply is seriously affected, a large ripple is generated, and stability of the processor is also seriously affected. This is especially true when a plurality of processors that is embedded in a single chip works in parallel.

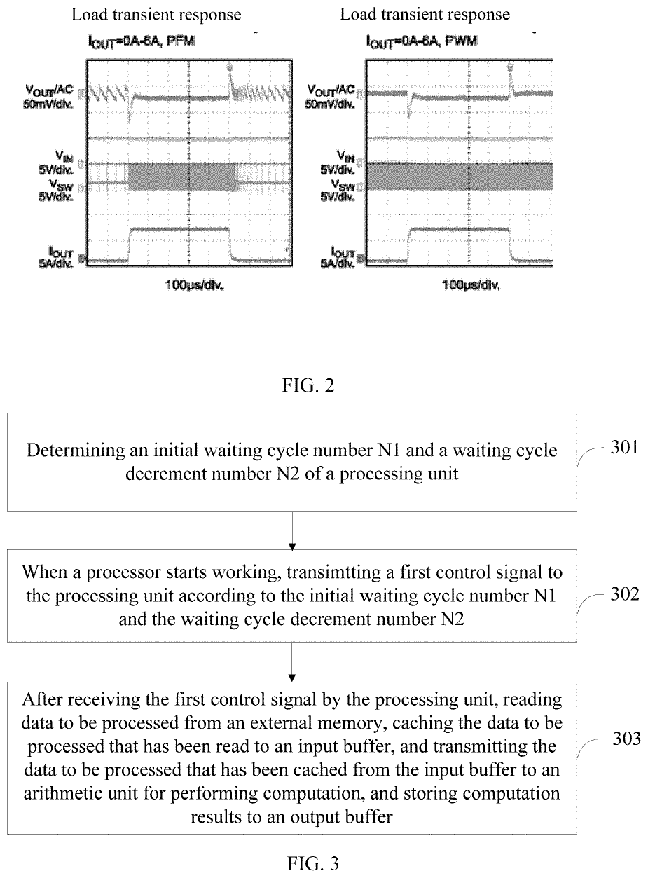

FIG. 2 is a schematic diagram of the ripple caused by the transient output current of the power supply changing from OA to 6A. As can be seen from FIG. 2, when the transient output current is changed from OA to 6A, the ripple voltage exceeds +50 mV/−50 mV, so that the large ripple voltage is easy to cause errors that the processor performs data transmission.

In an embodiment of the present disclosure, the controller 100 is configured to determine an initial waiting cycle number N1 and a waiting cycle decrement number N2 of the processing unit 102.

The initial waiting cycle number N1 and the waiting cycle decrement number N2 of the processing unit 102 can be set according to empirical values. For example, a corresponding relationship table between different processors and the initial waiting cycle number N1 and the waiting cycle decrement number N2 can be established, so that the initial waiting cycle number N1 and the waiting cycle decrement number N2 corresponding to the processor 10 can be determined according to the corresponding relationship table.

Alternatively, the controller 100 can be configured to determine the initial waiting cycle number N1 and the waiting cycle decrement number N2 of the processing unit 102 as follows:

(1) obtaining a ripple voltage generated by the processor 10 in an extreme working scenario.

The ripple voltage generated by the processor 10 in the extreme working scenario can be estimated by a simulation tool.

For example, the ripple voltage generated by the processor 10 in the extreme working scenario can be estimated by a simulation tool PTPX (PrimeTime PX). The simulation tool PTPX is a tool for analyzing static and dynamic power consumption of a whole chip based on a primetime environment.

In an embodiment of the present disclosure, referring to FIG. 2, the ripple voltage generated by the processor 10 is about +50 mV/−50 mV, when the transient output current of the processor 10 changes from OA to 6A in the extreme working scenario.

(2) determining the number of steps of current variation of the processor 10 according to the ripple voltage generated by the processor 10 in the extreme working scenario and a ripple voltage acceptable to the processor 10.

For example, the ripple voltage generated by the processor 10 in the extreme working scenario is about +50 mV/−50 mV, the ripple voltage acceptable to the processor 10 is about +20 mV/−20 mV, thereby, the number of steps of current variation of the processor 10 is three (that is 50 mV/20 mV round up to an integer).

(3) determining the waiting cycle decrement number N2 according to a switch cycle of the power supply 11 and a clock cycle of the processor 10.

In an embodiment of the present disclosure, the waiting cycle decrement number is proportional to the switch cycle of the power supply 11 and inversely proportional to the clock cycle of the processor 10.

In an embodiment of the present disclosure, the waiting cycle decrement number is (T1*n/T2), wherein T1 is the switch cycle of the power supply 11, T2 is the clock cycle of the processor 10, and n is a positive integer greater than 1. n can be a positive integer greater than or equal to 10 and less than or equal to 101, for example, n can be 20.

T1*n represents a length of each step of the current of the processor 10. For example, if the switch cycle of the power supply 11 is 1010 ns and n is 20, the length of each step of the current of the processor 10 is 20000 ns. It is assumed that the clock cycle of the processor 10 is 2 ns, the waiting cycle decrement number is 2000 ns/2 ns=10100.

(4) calculating the initial waiting cycle number N1 according to the number of steps and the waiting cycle decrement number N2.

In an embodiment of the present disclosure, the initial waiting cycle number N1 is equal to the product of the number of steps and the waiting cycle decrement number N2.

The power control unit 101 is configured to transmit a first control signal to the at least one processing unit 102 according to the initial waiting cycle number N1 and the waiting cycle decrement number N2, when the processor 10 starts working. A waiting time that the power control unit 101 transmits the first control signal for the first time is N1 clock cycles of the processor 10, the waiting time for subsequently transmitting the first control signal every time is decremented by N2 clock cycles, and if the waiting time decrements to be less than or equal to zero, the first control signal is transmitted every clock cycle.

For example, the initial waiting cycle number N1 is 1010, the waiting cycle decrement number N2 is 200, the power control unit 101 is configured to transmit the first control signal for the first time after waiting for 1010 clock cycles, transmit the first control signal for the second time after waiting for 800 clock cycles, transmit the first control signal for the third time after waiting for 600 clock cycles, transmit the first control signal for the fourth time after waiting for 400 clock cycles, transmit the first control signal for the fifth time after waiting for 200 clock cycles, and then, transmit the first control signal every clock cycle.

In an embodiment of the present disclosure, referring to FIG. 7, the power control unit 101 includes a first control register 70 configured to store the initial waiting cycle number, a second control register 72 configured to store the waiting cycle decrement number, and a control signal generating circuit 73 configured to output the first control signal according to data stored in the first control register 70 and the second control register 72.

After the processing unit 102 receives the first control signal, the processing unit 102 is configured to read data to be processed from the external memory 12, cache the data to be processed that has been read to the input buffer 1020, transmit the data to be processed that has been cached from the input buffer 1020 to the arithmetic unit 1021 for performing computation, and store computation results to the output buffer 1022.

Every time the processing unit 102 receives the first control signal, the processing unit 102 is configured to read the data to be processed from the external memory 12, cache the data to be processed that has been read to the input buffer 1020, transmit the data to be processed that has been cached from the input buffer 1020 to the arithmetic unit 1021 for performing computation, and store the computation results to the output buffer 1022. For example, after the processing unit 102 receives the first control signal sent from the power control unit 101 for the first time, the first piece of data to be processed is read from the external memory 12, the first piece of data to be processed that has been read is cached to the input buffer 1020, the first piece of data to be processed that has been cached is transmitted from the input buffer 1020 to the arithmetic unit 1021 for performing computation, and the computation results is stored to the output buffer 1022. After the processing unit 102 receives the first control signal sent from the power control unit 101 for the second time, the second piece of data to be processed is read from the external memory 12, the data to be processed that has been read is cached to the input buffer 1020, the data to be processed that has been cached is transmitted from the input buffer 1020 to the arithmetic unit 1021 for performing computation, and then computation results are stored to the output buffer 1022. After the processing unit 102 receives the first control signal sent from the power control unit 101 for the third time, the third piece of data to be processed is read from the external memory 12, the data to be processed that has been read is cached to the input buffer 1020, the data to be processed that has been cached is transmitted from the input buffer 1020 to the arithmetic unit 1021 for performing computation, and then computation results are stored to the output buffer 1022. After the processing unit 102 receives the first control signal sent from the power control unit 101 for the fourth time, the fourth piece of data to be processed is read from the external memory 12, the data to be processed that has been read is cached to the input buffer 1020, the data to be processed that has been cached is transmitted from the input buffer 1020 to the arithmetic unit 1021 for performing computation, and then computation results are stored to the output buffer 1022. After the processing unit 102 receives the first control signal sent from the power control unit 101 for the fifth time, the fifth piece of data to be processed is read from the external memory 12, the data to be processed that has been read is cached to the input buffer 1020, the data to be processed that has been cached is transmitted from the input buffer 1020 to the arithmetic unit 1021 for performing computation, and then computation results are stored to the output buffer 1022. And then, after receiving the first control signal sent from the power control unit 101 every clock cycle, the fifth piece of data to be processed is read from the external memory 12, the data to be processed that has been read is cached to the input buffer 1020, the data to be processed that has been cached is transmitted from the input buffer 1020 to the arithmetic unit 1021 for performing computation, and then the computation results are stored to the output buffer 1022.

In view of the power supply ripple problem caused by the processor 10 when the processor 10 starts working, the present embodiment is provided that the current of the power supply 11 can be controlled to rise sharply by controlling operation frequencies of the arithmetic unit 1021, so that the power consumption requirements of the processor 10 during starting working becomes stepped, so as to effectively reduce the power supply ripple when the processor 10 starts working, and improve stability of the processor 10.

In another embodiment of the present disclosure, the power control unit 101 is further configured to: if the number of remaining data to be processed in the external memory 12 is less than or equal to a preset value, send a second control signal to the at least one processing unit 102 according to the initial waiting cycle number N1 and the waiting cycle decrement number N2, wherein a waiting time that the power control unit 101 sends the second control signal for the first time is N2 clock cycles, the waiting time for subsequently transmitting the second control signal every time incremented by the N2 clock cycles, and if the waiting time increments to be greater than or equal to N1, the second control signal is sent every N1 clock cycles until the data to be processed in the external memory 12 is completely calculated.

For example, the initial waiting cycle number N1 is 1010, and the waiting cycle decrement number N2 is 200, if the number of pieces of remaining data to be processed in the external memory 12 is less than or equal to 10, the power control unit 101 is configured to transmit the second control signal for the first time after waiting for 200 clock cycles, transmit the second control signal for the second time after waiting for 400 clock cycles, transmit the second control signal for the third time after waiting for 600 clock cycles, transmit the second control signal for the fourth time after waiting for 800 clock cycles, transmit the second control signal for the fifth time after waiting for 1010 clock cycles. After that, the second control signal is transmitted every 1010 clock cycles until the data to be processed in the external memory 12 is completely calculated.

The at least one processing unit 102 is further configured to: after receiving the second control signal, read the data to be processed from the external memory 12, cache the data to be processed that has been read to the input buffer 1020, transmit the data to be processed that has been cached from the input buffer 1020 to the arithmetic unit 1021 for performing computation, and store the computation results to the output buffer 1022.

After the processing unit 102 receives the second control signal every time, the processing unit 102 is configured to read the data to be processed from the external memory 12, cache the data to be processed that has been read to the input buffer 1020, transmit the data to be processed that has been cached from the input buffer 1020 to the arithmetic unit 1021 for performing computation, and store the computation results to the output buffer 1022.

In an embodiment of the present disclosure, the control signal generating circuit 72 is further configured to output the second control signal according to data stored in the first control register 71 and the second control register 72.

The present embodiment is provided that the current of the power supply 11 can be controlled to drop sharply by controlling operation frequencies of the arithmetic unit 1021 when the processor 10 finishes working, so that the power consumption requirements of the processor 10 during starting working becomes stepped, so as to effectively reduce the power supply ripple when the processor 10 starts working, and improve stability of the processor 10.

FIG. 3 is a flowchart of a power supply ripple reduction method in accordance with an embodiment of the present disclosure.

The power supply ripple reduction method is applied to a processor. The processor is connected to a power supply and an external memory, and includes a controller, a power control unit, and at least one processing unit including an input buffer, an arithmetic unit and an output buffer.

In an embodiment of the present disclosure, the power supply ripple reduction method can be a neural network processing unit (NPU). A working principle of the neural network processing unit is to simulate human neurons and synapses at a circuit layer, and directly process large-scale neurons and synapses by a deep learning instruction set. One instruction is configured to process a group of neurons. Compared with the CPU and the GPU, the NPU integrates storage and calculation through synaptic weights, so as to improve operation efficiency thereof.

The power supply ripple reduction method is provided that the current of the power supply can be controlled to jump sharply by controlling operation frequencies of the arithmetic unit during starting the processor, so that the power consumption requirements of the processor during starting working becomes stepped, so as to effectively reduce the power supply ripple when the processor starts working and improve stability of the processor.

Referring to FIG. 3, the power supply ripple reduction method specifically includes the following steps:

Step 301, determining an initial waiting cycle number N1 and a waiting cycle decrement number N2 of a processing unit.

The initial waiting cycle number N1 and the waiting cycle decrement number N2 of the processing unit can be set according to empirical values. For example, a corresponding relationship table between different processors and the initial waiting cycle number N1 and the waiting cycle decrement number N2 can be established, thereby, the initial waiting cycle number N1 and the waiting cycle decrement number N2 corresponding to the processor can be determined according to the corresponding relationship table.

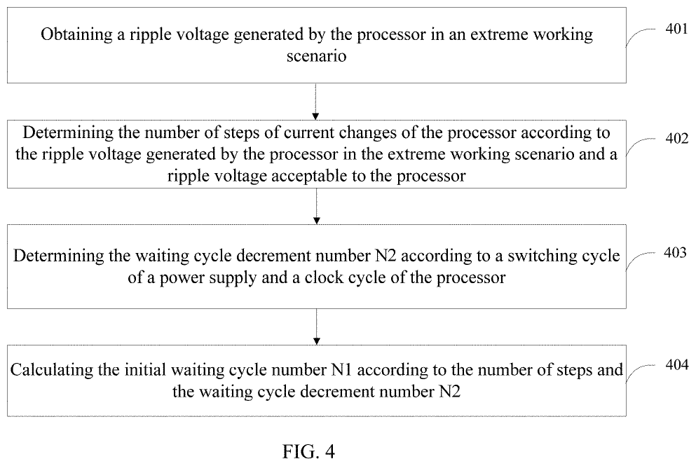

Alternatively, the initial waiting cycle number N1 and the waiting cycle decrement number N2 of the processing unit can be determined according to the method described in FIG. 4.

Step 302, when the processor starts working, the power control unit is configured to transmit a first control signal to the at least one processing unit according to the initial waiting cycle number N1 and the waiting cycle decrement number N2, a waiting time that the power control unit transmits the first control signal for the first time is N1 clock cycles of the processor, the waiting time for subsequently transmitting the first control signal every time is decremented by N2 clock cycles, and if the waiting time decrements to be less than or equal to zero, the first control signal is transmitted every clock cycle.

For example, the initial waiting cycle number N1 is 1010, the waiting cycle decrement number N2 is 200, the power control unit is configured to transmit the first control signal for the first time after waiting for 1010 clock cycles, transmit the first control signal for the second time after waiting for 800 clock cycles, transmit the first control signal for the third time after waiting for 600 clock cycles, transmit the first control signal for the fourth time after waiting for 400 clock cycles, transmit the first control signal for the fifth time after waiting for 200 clock cycles, and then, transmit the first control signal every clock cycle.

Step 303, after the at least one processing unit receives the first control signal, reading data to be processed from the external memory, caching the data to be processed that has been read to the input buffer, transmitting the data to be processed that has been cached from the input buffer to the arithmetic unit for performing computation, and storing computation results to the output buffer.

Every time the processing unit receives the first control signal, the processing unit is configured to read the data to be processed from the external memory, cache the data to be processed that has been read to the input buffer, transmit the data to be processed that has been cached from the input buffer to the arithmetic unit for performing computation, and store the computation results to the output buffer. For example, after the processing unit receives the first control signal sent from the power control unit for the first time, the first piece of data to be processed is read from the external memory, the first piece of data to be processed that has been read is cached to the input buffer, the first piece of data to be processed that has been cached is transmitted from the input buffer to the arithmetic unit for performing computation, and the computation results is stored to the output buffer. After the processing unit receives the first control signal sent from the power control unit for the second time, the second piece of data to be processed is read from the external memory, the data to be processed that has been read is cached to the input buffer, the data to be processed that has been cached is transmitted from the input buffer to the arithmetic unit for performing computation, and then computation results are stored to the output buffer. After the processing unit receives the first control signal sent from the power control unit for the third time, the third piece of data to be processed is read from the external memory, the data to be processed that has been read is cached to the input buffer, the data to be processed that has been cached is transmitted from the input buffer to the arithmetic unit for performing computation, and then computation results are stored to the output buffer. After the processing unit receives the first control signal sent from the power control unit for the fourth time, the fourth piece of data to be processed is read from the external memory, the data to be processed that has been read is cached to the input buffer, the data to be processed that has been cached is transmitted from the input buffer to the arithmetic unit for performing computation, and then computation results are stored to the output buffer. After the processing unit receives the first control signal sent from the power control unit for the fifth time, the fifth piece of data to be processed is read from the external memory, the data to be processed that has been read is cached to the input buffer, the data to be processed that has been cached is transmitted from the input buffer to the arithmetic unit for performing computation, and then computation results are stored to the output buffer. And then, after receiving the first control signal sent from the power control unit every clock cycle, the fifth piece of data to be processed is read from the external memory, the data to be processed that has been read is cached to the input buffer, the data to be processed that has been cached is transmitted from the input buffer to the arithmetic unit for performing computation, and then computation results are stored to the output buffer.

The present disclosure is configured to determine the initial waiting cycle number N1 and the waiting cycle decrement number N2 of the processing unit of the processor; the power control unit of the processor is configured to transmit the first control signal to the at least one processing unit according to the initial waiting cycle number N1 and the waiting cycle decrement number N2, when the processor starts working; wherein the waiting time that the power control unit transmits the first control signal for the first time is N1 clock cycles of the processor, the waiting time for subsequently transmitting the first control signal every time is decremented by N2 clock cycles, and if the waiting time decrements to be less than or equal to zero, the first control signal is transmitted every clock cycle. After receiving the first control signal, the at least one processing unit of the processor is configured to read data to be processed from the external memory, cache the data to be processed that has been read to the input buffer, transmit the data to be processed that has been cached from the input buffer to the arithmetic unit for performing computation, and store the computation results to the output buffer.

In an embodiment of the present disclosure, the power control unit includes a first control register configured to store the initial waiting cycle number, a second control register configured to store the waiting cycle decrement number, and a control signal generating circuit configured to output the first control signal according to data stored in the first control register and the second control register.

When the conventional processor starts working, the data to be processed is sent from the external memory to the arithmetic unit for performing computation in each clock cycle, so that current requirements of the processor at the nanosecond level are greatly changed, therefore, the voltage stability of the power supply is seriously affected, the large ripple is generated, and stability of the processor is also seriously affected. This is especially true when a plurality of processors embedded in a single chip works in parallel.

The present embodiment is provided that the current of the power supply can be controlled to rise sharply by controlling operation frequencies of the arithmetic unit, so that the power consumption requirements of the processor during starting working becomes stepped, so as to effectively reduce the power supply ripple when the processor starts working, and improve stability of the processor.

FIG. 4 is a detailed flowchart of determining the initial waiting cycle number N1 and the waiting cycle decrement number N2 of the processing unit of FIG. 3.

Referring to FIG. 4, determining the initial waiting cycle number N1 and the waiting cycle decrement number N2 of the processing unit includes the following steps:

Step 401, obtaining a ripple voltage generated by the processor in an extreme working scenario.

The ripple voltage generated by the processor in the extreme working scenario can be estimated by a simulation tool.

For example, the ripple voltage generated by the processor in the extreme working scenario can be estimated by a simulation tool PTPX (PrimeTime PX). The simulation tool PTPX is a tool for analyzing static and dynamic power consumption of a whole chip based on a primetime environment.

In an embodiment of the present disclosure, referring to FIG. 2, a ripple voltage generated by the processor is about +50 mV/−50 mV, when the transient output current of the processor changes from OA to 6A in the extreme working scenario.

Step 402, determining the number of steps of current variation of the processor according to the ripple voltage generated by the processor in the extreme working scenario and a ripple voltage acceptable to the processor.

For example, the ripple voltage generated by the processor 10 in the extreme working scenario is about +50 mV/−50 mV, the ripple voltage acceptable to the processor 10 is about +20 mV/−20 mV, thereby, the number of steps of current variation of the processor 10 is three (that is 50 mV/20 mV round up to an integer).

Step 403, determining the waiting cycle decrement number N2 according to a switch cycle of the power supply and a clock cycle of the processor.

In an embodiment of the present disclosure, the waiting cycle decrement number is proportional to the switch cycle of the power supply and inversely proportional to the clock cycle of the processor.

In an embodiment of the present disclosure, the waiting cycle decrement number is (T1*n/T2), wherein T1 is the switch cycle of the power supply 11, T2 is the clock cycle of the processor, and n is a positive integer greater than 1. n can be a positive integer greater than or equal to 10 and less than or equal to 101, for example, n can be 20.

T1*n represents a length of each step of the current of the processor. For example, if the switch cycle of the power supply is 1010 ns and n is 20, the length of each step of the current of the processor is 20000 ns. It is assumed that the clock cycle of the processor is 2 ns, the waiting cycle decrement number is 2000 ns/2 ns=10100.

Step 404, calculating the initial waiting cycle number N1 according to the number of steps and the waiting cycle decrement number N2.

In an embodiment of the present disclosure, the initial waiting cycle number N1 is equal to the product of the number of steps and the waiting cycle decrement number N2.

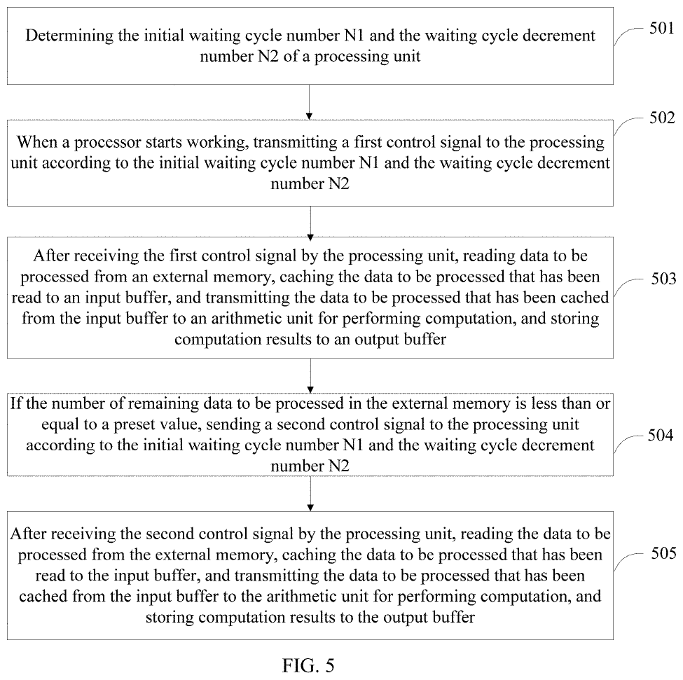

FIG. 5 is a flowchart of a power supply ripple reduction method in accordance with another embodiment of the present disclosure.

Referring to FIG. 5, the power supply ripple reduction method specifically includes the following steps:

Step 501, determining an initial waiting cycle number N1 and a waiting cycle decrement number N2 of a processing unit.

The initial waiting cycle number N1 and the waiting cycle decrement number N2 of the processing unit can be set according to empirical values. For example, a corresponding relationship table between different processors and the initial waiting cycle number N1 and the waiting cycle decrement number N2 can be established, and the initial waiting cycle number N1 and the waiting cycle decrement number N2 corresponding to the processor can be determined according to the corresponding relationship table.

Alternatively, the initial waiting cycle number N1 and the waiting cycle decrement number N2 of the processing unit can be determined according to the method described in FIG. 4.

Step 502, when the processor starts working, the power control unit is configured to transmit a first control signal to the at least one processing unit according to the initial waiting cycle number N1 and the waiting cycle decrement number N2, a waiting time that the power control unit transmits the first control signal for the first time is N1 clock cycles of the processor, the waiting time for subsequently transmitting the first control signal every time is decremented by N2 clock cycles, and if the waiting time decrements to be less than or equal to zero, the first control signal is transmitted every clock cycle.

For example, the initial waiting cycle number N1 is 1010, the waiting cycle decrement number N2 is 200, the power control unit is configured to transmit the first control signal for the first time after waiting for 1010 clock cycles, transmit the first control signal for the second time after waiting for 800 clock cycles, transmit the first control signal for the third time after waiting for 600 clock cycles, transmit the first control signal for the fourth time after waiting for 400 clock cycles, transmit the first control signal for the fifth time after waiting for 200 clock cycles, and then, transmit the first control signal every clock cycle.

Step 503, after the processing unit receives the first control signal, reading data to be processed from the external memory, caching the data to be processed that has been read to the input buffer, transmitting the data to be processed that has been cached from the input buffer to the arithmetic unit for performing computation, and storing computation results to the output buffer.

Every time the processing unit receives the first control signal, the processing unit is configured to read the data to be processed from the external memory, cache the data to be processed that has been read to the input buffer, transmit the data to be processed that has been cached from the input buffer to the arithmetic unit for performing computation, and store the computation results to the output buffer. For example, after the processing unit receives the first control signal sent from the power control unit for the first time, the first piece of data to be processed is read from the external memory, the first piece of data to be processed that has been read is cached to the input buffer, the first piece of data to be processed that has been cached is transmitted from the input buffer to the arithmetic unit for performing computation, and the computation results is stored to the output buffer. After the processing unit receives the first control signal sent from the power control unit for the second time, the second piece of data to be processed is read from the external memory, the data to be processed that has been read is cached to the input buffer, the data to be processed that has been cached is transmitted from the input buffer to the arithmetic unit for performing computation, and then computation results are stored to the output buffer. After the processing unit receives the first control signal sent from the power control unit for the third time, the third piece of data to be processed is read from the external memory, the data to be processed that has been read is cached to the input buffer, the data to be processed that has been cached is transmitted from the input buffer to the arithmetic unit for performing computation, and then computation results are stored to the output buffer. After the processing unit receives the first control signal sent from the power control unit for the fourth time, the fourth piece of data to be processed is read from the external memory, the data to be processed that has been read is cached to the input buffer, the data to be processed that has been cached is transmitted from the input buffer to the arithmetic unit for performing computation, and then computation results are stored to the output buffer. After the processing unit receives the first control signal sent from the power control unit for the fifth time, the fifth piece of data to be processed is read from the external memory, the data to be processed that has been read is cached to the input buffer, the data to be processed that has been cached is transmitted from the input buffer to the arithmetic unit for performing computation, and then computation results are stored to the output buffer. And then, after receiving the first control signal sent from the power control unit every clock cycle, the fifth piece of data to be processed is read from the external memory, the data to be processed that has been read is cached to the input buffer, the data to be processed that has been cached is transmitted from the input buffer to the arithmetic unit for performing computation, and then computation results are stored to the output buffer.

Step 504, if the number of remaining data to be processed in the external memory is less than or equal to a preset value, the power control unit is further configured to transmit a second control signal to the at least one processing unit according to the initial waiting cycle number N1 and the waiting cycle decrement number N2, wherein a waiting time that the power control unit transmits the second control signal for the first time is N2 clock cycles, the waiting time for subsequently transmitting the second control signal every time incremented by the N2 clock cycles, and if the waiting time increments to be greater than or equal to N1, the second control signal is transmitted every N1 clock cycles until the data to be processed in the external memory is completely calculated.

For example, the initial waiting cycle number N1 is 1010, and the waiting cycle decrement number N2 is 200, if the number of pieces of remaining data to be processed in the external memory is less than or equal to 10, the power control unit is configured to: transmit the second control signal for the first time after waiting for 200 clock cycles, transmit the second control signal for the second time after waiting for 400 clock cycles, transmit the second control signal for the third time after waiting for 600 clock cycles, transmit the second control signal for the fourth time after waiting for 800 clock cycles, transmit the second control signal for the fifth time after waiting for 1010 clock cycles. After that, the second control signal is transmitted every 1010 clock cycles until the computation of the data to be processed in the external memory is completely calculated.

Step 505, after receiving the second control signal, the at least one processing unit is further configured to read the data to be processed from the external memory, cache the data to be processed that has been read to the input buffer, transmit the data to be processed that has been cached from the input buffer to the arithmetic unit for performing computation, and store the computation results to the output buffer.

After the processing unit receives the second control signal every time, the processing unit is configured to read the data to be processed from the external memory, cache the data to be processed that has been read to the input buffer, transmit the data to be processed that has been cached from the input buffer to the arithmetic unit for performing computation, and store computation results to the output buffer.

The power supply ripple reduction method in the second embodiment of the present disclosure is configured to determine the initial waiting cycle number N1 and the waiting cycle decrement number N2 of the processing unit; the power control unit is configured to transmit the first control signal to the at least one processing unit according to the initial waiting cycle number N1 and the waiting cycle decrement number N2, when the processor starts working; wherein the waiting time that the power control unit transmits the first control signal for the first time is N1 clock cycles of the processor, the waiting time for subsequently transmitting the first control signal every time is decremented by N2 clock cycles, and if the waiting time decrements to be less than or equal to zero, the first control signal is transmitted every clock cycle. After receiving the first control signal, the at least one processing unit is configured to read data to be processed from the external memory, cache the data to be processed that has been read to the input buffer, transmit the data to be processed that has been cached from the input buffer to the arithmetic unit for performing computation, and store the computation results to the output buffer. If the number of remaining data to be processed in the external memory is less than or equal to the preset value, the power control unit is further configured to transmit the second control signal to the at least one processing unit according to the initial waiting cycle number N1 and the waiting cycle decrement number N2, wherein the waiting time that the power control unit transmits the second control signal for the first time is N2 clock cycles, the waiting time for subsequently transmitting the second control signal every time incremented by the N2 clock cycles, and if the waiting time increments to be greater than or equal to N1, the second control signal is transmitted every N1 clock cycles until the data to be processed in the external memory is completely calculated. After receiving the second control signal, the at least one processing unit is further configured to read the data to be processed from the external memory, cache the data to be processed that has been read to the input buffer, transmit the data to be processed that has been cached from the input buffer to the arithmetic unit for performing computation, and store the computation results to the output buffer.

The power supply ripple reduction method in the second embodiment of the present disclosure can control the operation frequencies of the arithmetic unit not only when the processor starts working, but also when the processor ends working, so as to control the current of the power supply to rise/drop sharply, so that the power consumption requirements of the processor during starting working and ending working becomes stepped, so as to effectively reduce the power supply ripple of the power supply at the start and end of the work, and improve stability of the processor.

In an embodiment of the present disclosure, the power control unit includes a first control register configured to store the initial waiting cycle number, a second control register configured to store the waiting cycle decrement number, and a control signal generating circuit configured to output the first control signal and the second control signal according to data stored in the first control register and the second control register.

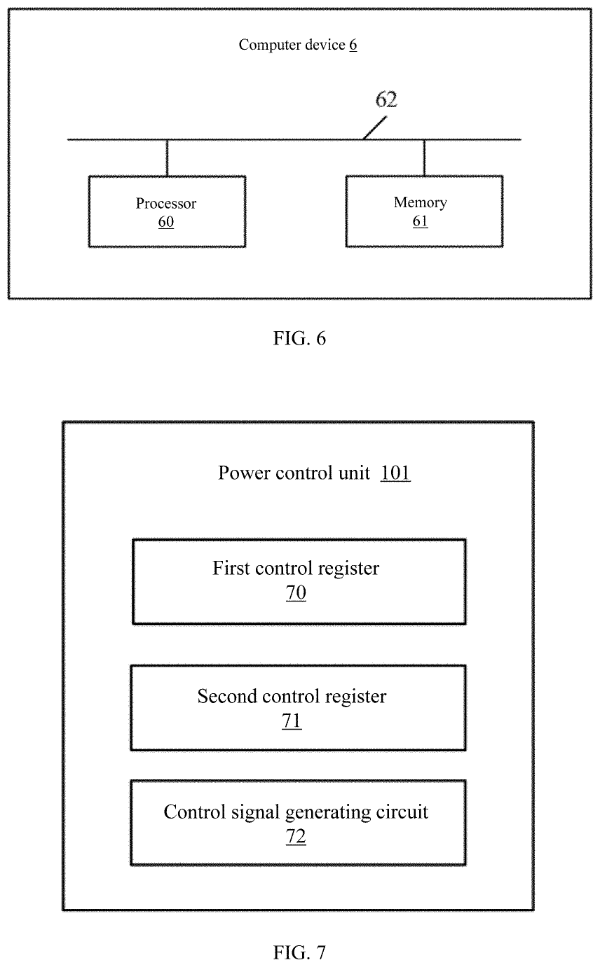

FIG. 6 illustrates a schematic diagram of a computer device in accordance with an embodiment of the present disclosure.

In an embodiment of the present disclosure, the computer device 6 includes a processor 60, a memory 61 and at least one communication bus 62. The processor 60 can a processor 10 as shown in FIG. 1 so as to implement the steps of the above power supply ripple reduction method, such as the steps 301-303 of FIG. 3 or the steps 501-505 of FIG. 5.

The computer device 6 can be a computing device such as a desktop computer, a notebook, a handheld computer and a cloud server. An ordinary skilled person in the art can be understood that: FIG. 6 is only an example of the computer device 6, but not limited to include more or less components shown in FIG. 6, or some combination of components, or different components. For example, the computer device 6 can also include input/output devices, network access devices, buses, etc.

The computer device 6 can be a Central Processing Unit (CPU), and other general purpose processors, Digital Signal Processors (DSP), Application Specific Integrated circuits (ASIC), ready-made Programmable Gate Array (FIELD-Programmable Gate Array, FPGA), or other programmable logic devices, discrete gate or transistor logic devices, discrete hardware components, etc. The general purpose processor can be a microprocessor or the processor 60 can be any conventional processor, etc. The processor 60 is a control center of the computer device 6 to connect various parts of the entire computer device 6 with various interfaces and wires.

The memory 61 is configured to store computer programs and/or modules/cells, the processor 60 is configured to perform the computer programs and/or modules/units stored in the memory 61 and call data stored in the memory 61 to implement various functions of the computer device 6. The memory 61 can mainly include a storage program area and a storage data area, wherein the storage program area is configured to store an operation system, applications required by at least one function; the storage data area is configured to store data created by the computer device 6 according to usage of the computer device 6, and so on. In addition, the memory 61 can include a non-volatile memory, for example, hard disks, memories, plug-in hard disks, Smart Media Cards (SMC), Secure Digital (SD) Cards, Flash Cards, at least one disk storage device, Flash memory devices, or other volatile solid state storage devices.

The modules/units integrated by the computer device 6 can be stored in a computer readable memory if implemented in the form of software program modules and sold or used as a separate product. Based on this understanding, all or part of the steps in the method of the above embodiment in the present disclosure can be implemented by computer program instructions of relevant hardware which can be stored in a computer readable storage medium, the computer program can be performed by the processor to implement the steps in the various methods of the above embodiments. Furthermore, the computer program includes computer program codes, which can be in a form of source codes, object codes, executable files or some intermediate forms, etc. The computer readable medium can include: any entities or devices capable of carrying the computer program codes, a recording medium, a U disk, a mobile hard disk drive, a diskette or a CD-ROM, a computer Memory, a Read-Only Memory (ROM), a Random Access Memory (RAM), an electrical carrier signal, a telecommunication signal and a software distribution medium, etc. It should be noted that content contained in the computer readable storage medium can be added or reduced as appropriate to the requirements of legislation and patent practice within the jurisdictions, for example, in some jurisdictions, in accordance with legislation and patent practice, computer readable storage medium do not include electrical carrier signals and telecommunications signals.

In addition, each functional unit in each embodiment of the present disclosure can be integrated in the same processing unit, or each unit can be separately formed with a physical form, or two or more units can be integrated in one unit. The above integrated units can be implemented either in a hardware form or in the form of hardware plus software function modules.

It should be understood that the disclosed computer device and method in the embodiments provided by the present disclosure can be implemented in other ways. For example, the embodiments of the computer device described above are merely schematic; for example, the division of the modules or units is merely a division of logical functions, which can also be realized in other ways.

A computer readable storage medium according to an embodiment of the present disclosure is configured to store computer programs, when the computer programs are performed by a processor, the computer device can be configured to implement steps and processes of the image retrieval method of the present disclosure, and implement the same technical effect, which is not be repeated here in order to avoid repetition of the present disclosure.

1. A processor comprising a controller and at least one processing unit, the at least one processing unit comprising an input buffer, an arithmetic unit and an output buffer, the processor connected to a power supply and an external memory, the controller configured to determine an initial waiting cycle number N1 and a waiting cycle decrement number N2 of the at least one processing unit, the processor further comprising a power control unit and configured to:
transmit a first control signal to the at least one processing unit according to the initial waiting cycle number N1 and the waiting cycle decrement number N2, when the processor starts working; wherein a waiting time that the power control unit transmits the first control signal for the first time is N1 clock cycles of the processor, the waiting time for subsequently transmitting the first control signal every time is decremented by N2 clock cycles, and if the waiting time decrements to be less than or equal to zero, the first control signal is transmitted every clock cycle; and wherein
after receiving the first control signal, the at least one processing unit is configured to read data to be processed from the external memory, cache the data to be processed that has been read to the input buffer, transmit the data to be processed that has been cached from the input buffer to the arithmetic unit for performing computation, and store computation results to the output buffer.

2. The processor as claimed in claim 1, wherein the step of determining the initial waiting cycle number N1 and the waiting cycle decrement number N2 of the at least one processing unit comprises:
obtaining a ripple voltage generated by the processor in an extreme working scenario;
determining the number of steps of current variation of the processor according to the ripple voltage generated by the processor in the extreme working scenario and a ripple voltage acceptable to the processor;
determining the waiting cycle decrement number N2 according to a switch cycle of the power supply and a clock cycle of the processor; and
calculating the initial waiting cycle number N1 according to the number of steps and the waiting cycle decrement number N2.

3. The processor as claimed in claim 1, wherein the power control unit comprises a first control register configured to store the initial waiting cycle number N1, a second control register configured to store the waiting cycle decrement number N2, and a control signal generating circuit configured to output the first control signal according to data stored in the first control register and the second control register.

4. The processor as claimed in claim 1, wherein the power control unit is further configured to:
if the number of remaining data to be processed in the external memory is less than or equal to a preset value, transmit a second control signal to the at least one processing unit according to the initial waiting cycle number N1 and the waiting cycle decrement number N2, wherein a waiting time that the power control unit transmits the second control signal for the first time is N2 clock cycles, the waiting time for subsequently transmitting the second control signal every time is incremented by the N2 clock cycles, and if the waiting time increments to be greater than or equal to N1, the second control signal is transmitted every N1 clock cycles until the data to be processed in the external memory is completely calculated; and wherein
the at least one processing unit is further configured to:
after receiving the second control signal, read the data to be processed from the external memory, cache the data to be processed that has been read to the input buffer, transmit the data to be processed that has been cached from the input buffer to the arithmetic unit for performing computation, and store computation results to the output buffer.

5. A power supply ripple reduction method applied to a processor, the processor connected to a power supply and an external memory, and comprising a controller, a power control unit, and at least one processing unit, the at least one processing unit comprising an input buffer, an arithmetic unit and an output buffer; the method comprising:
determining an initial waiting cycle number N1 and a waiting cycle decrement number N2 of the at least one processing unit;
transmitting a first control signal to the at least one processing unit according to the initial waiting cycle number N1 and the waiting cycle decrement number N2, when the processor starts working; wherein a waiting time that the power control unit transmits the first control signal for the first time is N1 clock cycles of the processor, the waiting time for subsequently transmitting the first control signal every time is decremented by N2 clock cycles, and if the waiting time decrements to be less than or equal to zero, the first control signal is transmitted every clock cycle;
after the at least one processing unit receives the first control signal, reading data to be processed from the external memory, caching the data to be processed that has been read to the input buffer, transmitting the data to be processed that has been cached from the input buffer to the arithmetic unit for performing computation, and storing computation results to the output buffer.

6. The method as claimed in claim 5, wherein the step of determining the initial waiting cycle number N1 and the waiting cycle decrement number N2 of the at least one processing unit comprises:
obtaining a ripple voltage generated by the processor in an extreme working scenario;
determining the number of steps of current variation of the processor according to the ripple voltage generated by the processor in the extreme working scenario and a ripple voltage acceptable to the processor;
determining the waiting cycle decrement number N2 according to a switch cycle of the power supply and a clock cycle of the processor; and
calculating the initial waiting cycle number N1 according to the number of steps and the waiting cycle decrement number N2.

7. The method as claimed in claim 5, wherein the waiting cycle decrement number N2 is proportional to the switch cycle of the power supply and inversely proportional to the clock cycle of the processor.

8. The method as claimed in claim 5, wherein the waiting cycle decrement number N2 is (T1*n/T2), wherein T1 is the switch cycle of the power supply, T2 is the clock cycle of the processor, and n is a positive integer greater than 1.

9. The method as claimed in claim 5, wherein the power control unit comprises a first control register configured to store the initial waiting cycle number N1, a second control register configured to store the waiting cycle decrement number N2, and a control signal generating circuit configured to output the first control signal according to data stored in the first control register and the second control register.

10. The method as claimed in claim 5, wherein if the number of remaining data to be processed in the external memory is less than or equal to a preset value, the method further comprises:
transmitting by the power control unit, a second control signal to the at least one processing unit according to the initial waiting cycle number N1 and the waiting cycle decrement number N2, wherein a waiting time that the power control unit transmits the second control signal for the first time is N2 clock cycles, the waiting time for subsequently transmitting the second control signal every time is incremented by the N2 clock cycles, and if the waiting time increments to be greater than or equal to N1, the second control signal is transmitted every N1 clock cycles until the data to be processed in the external memory is completely calculated; and
after the at least one processing unit receiving the second control signal, reading the data to be processed from the external memory, caching the data to be processed that has been read to the input buffer, transmitting the data to be processed that has been cached from the input buffer to the arithmetic unit for performing computation, and storing computation results to the output buffer.
